(19) United States
(12) Patent Application Publication
(10) Pub. No.: US 2024/0402904 A1
(43) Pub. Date: Dec. 5, 2024

(54) Stimulating acupuncture meridians through touching images on a smart phone with imprinted acupuncture meridian endogenous frequencies;

(71) Applicant: James Hubbard, Alexandria, VA (US)

(72) Inventor: James Hubbard, Alexandria, VA (US)

(21) Appl. No.: 18/772,204

(22) Filed: Jul. 14, 2024

Related U.S. Application Data
(63) Continuation-in-part of application No. 17/301,023, filed on Mar. 22, 2021.

(51) Int. Cl. G06F 3/0488; A61H 39/00; G06T 11/00

(52) U.S. Cl. CPC G06F 3/0488; A61H 39/00; G06T 11/00

(57) ABSTRACT

The invention allows the imprinting or stimulating of acupuncture meridians for 5 to 10 minutes through touching, with an index finger for 30 seconds to 2 minutes, a displayed image on a smartphone of reflected scattered light modulated by coherent domains in [symbol] cardboard card which are modulated by a magnetic field at the acupuncture [symbol] endogenous frequencies. The image of the reflected scattered light [symbol] modulated by acupuncture endogenous frequencies can be photographed by a smartphone digital camera on a white cardboard card against a low frequency voice coil with the endogenous frequencies energizing the coil.

### CROSS-REFERENCE TO RELATED APPLICATIONS

The invention was not publicly used anywhere in the work.

The invention was not offered for sale anywhere in the work.

The invention was not patented anywhere in the world.

The invention was not described in a printed publication or was available to the public anywhere in the world.

### STATEMENT REGARDING FEDERALLY SPONSORED RESEARCH OR DEVELOPMENT (IF APPLICABLE)

The invention was not made under a contract with an agency of the U.S. Government

### BACKGROUND OF THE INVENTION

This invention is one of method. QED theory showed that water at 300 K was a mixture comprising 28% coherent water in 75 nm coherent domains interspersed with the remaining 72% as incoherent or vapour-like water. It is the coherent water that has the “memory” properties. The incoherent water is responsible for the normal thermodynamic properties. This theory was the first to give the experimentally determined values for many of the physical properties of water including: critical volume; boiling temperature; latent heat of vaporisation; specific heat; the specific heat and compressibility anomaly at 230K; density anomaly at freezing point and the low frequency dielectric constant for water. The coherent phase of water consists of coherent domains (CDs) where water molecules oscillate in phase with a resonating electromagnetic field. As temperature increases, the coherent fraction decreases due to increased thermal fluctuations that extract more water molecules from the coherent phase into the incoherent phase.

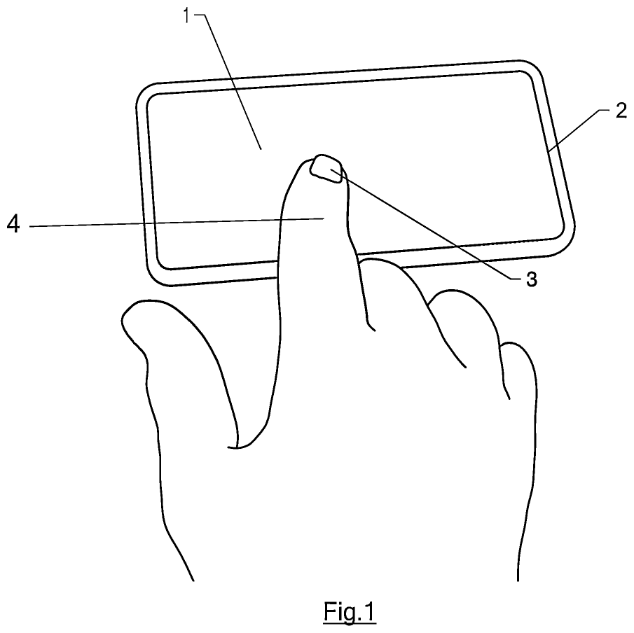

Today acupuncture therapy may involve the involvement of an acupuncture therapist, time to go to him/her, fee for services and scheduling. The acupuncturist would put needles into various acupuncture points along a specific meridian to stimulate the meridian and unblock the Qi—flow of energy—through the meridian for a healthier functioning system. Acupuncture has been approved by the NIH as a medical therapy for decades. When an acupuncture point is stimulated it stimulates the endogenous frequency of that meridian to spread all over the acupuncture meridian system of the body for a period of time thus unblocking meridians. An alternate therapy, acupressure, is to use pressure on acupuncture points to stimulate the points and the meridian—this requires extensive technical experience and knowledge to do this properly and it is less effective than acupuncture. This invention makes acupuncture therapy accessible on a smart phone wherever one is, whenever one needs it and therapy as much as needed, inexpensively through touching images with specific acupuncture meridian endogenous frequencies imprinted in them as can be seen in FIG. 1.

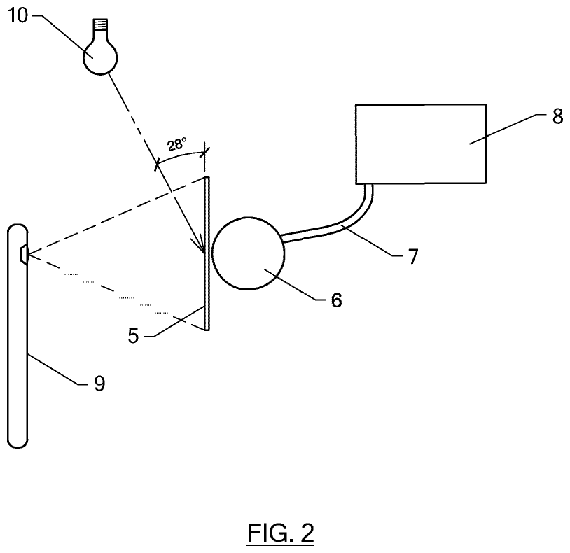

There has been imprinting of frequencies in coherent domains (CD) in tubes of water with a coil which one would hold to imprint on the acupuncture meridian system but this is cumbersome carrying around tudes of water. FIG. 2 shows the production of digital images with acupuncture meridian endogenous frequencies imprinted in it. To my knowledge this process has not been used before for this use.

### BRIEF SUMMARY OF THE INVENTION

This invention brings acupuncture therapy—stimulation and imprinting of acupuncture meridians—to the user conveniently, inexpensively, without an acupuncturist and related fee and logistics, with little technical knowledge to the user through touching a smartphone image. Looking at FIG. 1 one can see the digital image with acupuncture meridian endogenous frequencies imprinted in it 1, the smart phone displaying it 2 and touching the image with an index finger for 30 seconds to 2 minutes 3. This touching stimulates and imprints acupuncture meridians for 5 to 10+ minutes all over the acupuncture meridian system with this particular meridian endogenous frequency. This can be repeated as needed.

The creation of the digital images with acupuncture meridian endogenous frequencies imprinted in it is depicted in FIG. 2.

### BRIEF DESCRIPTION OF THE SEVERAL VIEWS OF THE DRAWING

In FIG. 1 we see the process of the stimulation of the acupuncture meridian endogenous frequencies: one can see the digital image with acupuncture meridian endogenous frequencies imprinted in it 1, the smart phone displaying it 2 and touching the image with an index finger for 30 seconds to 2 minutes 3.

The creation of the digital images with acupuncture meridian endogenous frequencies imprinted in it is depicted in FIG. 2. The smart phone 9, photographs card 5 illuminated by LEDs 10 in front of coil 6 connected by cable 7 to signal generator 8 which is generating specific frequencies.

### DETAILED DESCRIPTION OF THE INVENTION

For the method in FIG. 1 we see the method of imprinting acupuncture meridian endogenous frequencies: one can see the digital image with acupuncture meridian endogenous frequencies imprinted in it 1, the smart phone displaying it 2 and touching the image with an index finger for 30 seconds to 2 minutes 3. There is a method of imprinting/stimulation of the acupuncture meridian endogenous frequencies in the literature through holding a tube of water with frequencies imprinted in the coherent domains, but the tubes are too cumbersome. There is also a method of imprinting frequencies into coherent domains in a tube of water by scattered light modulated by those frequencies in the literature but not imprinting frequencies directly into a finger and acupuncture meridian system through a finger by touching an image of modulated reflected scattered light.

The creation pf the digital images with acupuncture meridian endogenous frequencies imprinted in it is depicted in FIG. 2. The smart phone 9 with camera, photographs white cardboard card, filling the frame, illuminated by LEDs at 28 degrees+ with about 320 LUX on it 10 vertically against a 4″ woofer voice coil 6 connected by cable 7 to signal generator at about 0.5 Volt 8 which is generating specific acupuncture meridian endogenous frequencies. In the literature, there is a process of imprinting frequencies into coherent domains in a tube of water through modulated reflected scattered light from an image with frequencies imprinted in it, but not imprinting frequencies directly into a finger into the acupuncture meridian system.

The inventor performed experiments establishing that endogenous acupuncture meridian frequencies could be imprinted into an acupuncture meridian system via a digital image of reflected scattered light modulated by coherent domains in moisture on a cardboard card modulated by a magnetic field of those frequencies. Reflected scattered light modulated by coherent domains (CD) in moisture on the card—from normal humidity—modulated by a magnetic field of various frequencies can imprint those frequencies into blank water CD or the CD of a finger and acupuncture meridian system of a human being via a finger at close proximity. These digital images with acupuncture meridian endogenous frequencies imprinted in them would be available for purchase. Each acupuncture meridian has a unique endogenous frequency from 0.00055 Hz to an upper range frequency of 300,000 MHz.

There is a method of imprinting/stimulation of the acupuncture meridian endogenous frequencies in the literature through holding a tube of water with frequencies imprinted in the coherent domains, but the tubes are too cumbersome. There is also a method of imprinting frequencies into coherent domains in a tube of water by scattered light modulated by those frequencies in the literature but not imprinting frequencies directly into the finger and acupuncture meridian system through a finger by touching an image of modulated reflected scattered light.

### Science Supporting the Claim

All scientific publications, cited herein and in IDS pages 1 and 2, are incorporated by reference herein in its entirety.

IDS Citation 6, 7 Coherent Domains in water QED theory showed that water at 300 K was a mixture comprising 28% coherent water in 75 nm coherent domains interspersed with the remaining 72% as incoherent or vapour-like water. It is the coherent water that has the “memory” properties. The incoherent water is responsible for the normal thermodynamic properties. This theory was the first to give the experimentally determined values for many of the physical properties of water including: critical volume; boiling temperature; latent heat of vaporization; specific heat; the specific heat and compressibility anomaly at 230K; density anomaly at freezing point and the low frequency dielectric constant for water. Fröhlich applied the Kirkwood formula to get a value of 63 for the static dielectric constant of water compared with the experimental value of 78.

1. Liquid water consists of two phases at each temperature: a coherent phase and a normal phase[1][2].

2. When water density exceeds a critical threshold, an ensemble of water molecules evolves towards a coherent ground state[2].

3. In this coherent state, water molecules oscillate in unison between two single-particle states, in tune with a trapped electromagnetic field[4].

4. The size of the coherent domain in water is determined by the wavelength of the molecular oscillation[4].

5. The coherent oscillation arises from quantum fluctuations that grow and lead to a state where matter oscillates in phase with resonant electromagnetic field modes[4].

6. This coherent behavior emerges due to a fundamental instability above a certain density threshold[4].

7. The coherent state coexists with the normal phase, with molecules continuously transitioning between the two phases[3].

8. The formation of coherent domains in water is explained through quantum electrodynamics (QED) principles[3][4].

This QED approach to understanding water's behavior provides insights into its unique properties and potential role in biological systems, particularly in relation to the formation of exclusion zone (EZ) water near hydrophilic surfaces[3].

### SOURCES

[1] QED COHERENCE AND THE THERMODYNAMICS OF WATER https://www.worldscientific.com/doi/10.1142/S0217979295000744
[2] QED Coherence and the Thermodynamics of Water—NASA/ADS http://ui.adsabs.harvard.edu/abs/1995IJMPB9.1813A/abstract
[3] [PDF] The origin and the special role of coherent water in living systems https://www.emmind.net/openpapers_repos/Endogenous_Fields—Mind/Water_EMF/Exclusion_Zones/2014_The_origin_and_the_special_role_of_coherent_water_in_living_systems.pdf
[4] [PDF] QED, Water, Experiments—Robert Haralick http://haralick.org/conferences/water_conf_2022_slides.pdf
[5] The origin and the special role of coherent water in living systems https://www.researchgate.net/publication/278966130_The_origin_and_the_special_role _of_coherent_water_in_living_systems

### IDS Citation 13 EMF Hypersensitive Patients

The author commenced cooperation with an allergy clinic in 1982 (Smith et al., 1990) to assist with their electrically hypersensitive patients. The patients were tested using electrical oscillators to give controlled frequencies with fields typical of those to be found in the environment, particularly near televisions and computers. Frequency turned out to be the relevant parameter once some intensity or field threshold had been exceeded.

This technique fit well with the allergy provocation/neutralization tests and therapy being used in the clinic. It was used in double-blinded trials at the Environmental Health Center in Dallas, TX, which finally achieved 100% reactions to that frequency to which each subject was most sensitive and 0% responses to placebos.

IDS citations: 11, 13, 16—Ch 4, 17, 18 Smith and Monro successfully treated electromagnetic sensitivity in allergy patients for ˜40 years—since 1982—up until Smith's death in 2022. They would find neutralizing frequencies from a signal generator/coil—patient had no reaction—or patient holding a tube of water imprinted with such frequencies. This also applied to finding sensitive frequencies as well.

Exposure of a patient to EMF frequencies during an allergic reaction would sensitize a patient to an EMF frequency. The frequencies would imprint into coherent domains in a tube water by exposure to EMF frequencies from a coil and imprint into coherent domains of a body of a patient by holding a tube of water with imprinted coherent domains.

IDS citations 1, 2, 3, 14, 17 Water and trace water imprinted coherent domains can modulate light and modulated light can imprint frequencies into water coherent domains.

IDS citation 4, nature of bioinformation in water, 7, 8, 17: measurement of the speed of diffusion of coherent domains.

IDS citations 9, 10: Modulated light from an image can imprint frequencies into coherent domains in the finger and body and coherent domains in water.

### IDS Citation 10:

### JCH Frequency Experiments Verify:

1 Quantum dowsing (15): comparing imprinted frequencies in photos, water and trace water of materials against coil at such frequencies.

2 photo of modulated light by body, coil, trace water coherent domains can modulate coherent domains in water and acupuncture meridians.

### Endogenous Acupuncture Frequency Experiments:

1. Pipette of blanked water (boiled water which is put in a steel container for an hour) (typ) tip placed at acupuncture point He9 for 30 seconds=7.8 Hz as dowsed against 7.8 Hz.
   EMF signal generated coil. Normal: Pe9=0.25 Hz, He9=7.8 Hz
2. Pipette at acupuncture point Pe9=<1 Hz
3. He9 point stimulated, pipette at Pe9=7.8 Hz
4. Holding in right hand 7.8 Hz jar of imprinted water for 30 s, pipette at Left Pe9=7.8 Hz
5 30 s exposure to 7.8 Hz Coil @4′ pipette at Pe9 30 s=7.8 Hz
6. Exercise walking/bike riding keeps Acupuncture point Pe9 7.8 Hz for ˜half hour after exercise before returning to <1 Hz
7. 30 s exposure of 4 Hz Coil @4′ distance-pipette Pe9 30 s=1 Hz
8. Holding in left hand 7.8 Hz jar of imprinted water for 30 s pipette on Left Pe9=7.8 Hz
9. Meditate for 30 min. pipette at Pe9=7.8 Hz for 23 min
10. Pe9=7.8 Hz for >10 min
11 Drink 2-Grams Vit C dissolved in water, after 5 min Pe9=7.8 Hz, goes back to <1 Hz later.
12. Top of head chakra=<1 Hz
13. Solution of baicalin (chinese anti-viral skull cap herb extract with purported anti-covid 19 infection activity) magnet-blank water-imprinted water=7.8, 15 Hz.
14. Steel pan with lid, boiled water cooling on stone pavers has 7.8 Hz imprinted in it—Schuman resonance?.
15. Coil and jar of 7.8 Hz water covered with magnetic shielding fabric still work for dowsing.
16. Magnet=2.5 uT: Magnet with shield=0.5 uT
17. Coil 0.02 uT 7.8 Hz @ 1′. @8′. 30 s Pe9=7.8 Hz; @10′ 30 s=7.8 Hz; @12′ 30 s Pe9=7.8 Hz;
18. Hold 7.8 Hz water for 30 s, touch top of head of another person with middle finger, person's Pe9=7.8 Hz.
19. Held 7.8 Hz water for 30 s, Pe9=7.8 Hz for 10+ min.
20. Hold water in hand for 5 minutes, no frequency; Hand mag water for 5 minutes=endogenous frequencies;
21. Hold picture of water in hand for 5 min, Pe9=all Acupuncture meridian (AM) frequencies.
22 tube (of blanked water) on picture with light and with magnet 15 cm away for 6 minutes=All Endogenous frequencies.
23. Tube (blanked water) over print of photo of tube with light for 5 minutes which was over photo for 5 minutes=similar to original tube; tube over blank paper=no frequencies.
24. Pipette (with blanked water) on Pe9 for 30 s=0.25 Hz, photo on white background, blanked water in tube on photo for 5 minutes=0.25 Hz
25. Finger on photo for 5 min—with LED light, Pe9=0.25 Hz
26. Laser through 7.8 water to pointing finger, Pe9=7.8 Hz
27. Laser reflected from picture to finger, Pe9=AMF
28. Coil-magnet-water 30 s at 9.1 Hz; Print pic of tube, finger on picture of tube with reflect led light for 2 min, Pe9=9.1 Hz
29. Coil mag tube at 7.8 for 2 min; Finger on photo of tube in light for 2 min, Pe9=7.8 Hz
30 Laser through 7.8 water to pointer finger for 30 s, Pe9=7.8; same with another person.
31. Exposure 12″ to pic of tube 7.8 Hz on computer for 5 minutes, Pe9=7.8 Hz
32. Laser-490 nm through 7.8 Hz tube of water to tube of (blanked) water for 30 s=7.8 Hz
33. Tube of blanked water on phone pic of 7.8 Hz tube for 5 min=7.8 Hz.
38. Photo of 7.8 Hz tube on phone, index finger on it for 30 s Pe9=7.8 Hz.
34. Pic of tube of 7.8 Hz water measures 7.8 Hz through dowsing against coil.
35. Paper in front of coil at 5.5 Hz, photo of lighted card on iPhone=5.5 Hz
36 blue laser close over 7.8 Hz image on phone into water for 30 seconds—water=7.8 Hz no 24 Hz
37. Blue laser close over 0.48 Hz image on phone into water for 30 seconds—water equals 0.48. Hz
38. Finger on 7.8 Hz image on phone for 30 s Pe9=7.8 Hz after 15 minutes.
39. Red laser over 0.48 Hz image into water for 30 s=0.48 Hz No 24 Hz,
40. Touch 7.8 image on phone 30 seconds measure top of head chakra=7.8 Hz (normally 0.25 Hz)
41. Touch 0.25 Hz image on phone 30 s. Measure top of head chakra=0.25 Hz
42 Photographed He9 and Top of head chakra. He9=7.8 Hz, Chakra=0.25 Hz.
43 pic of each acupuncture point on the heart meridian measured to be 7.8 Hz.
44. Pe9=0.25; Laser on He9 for 30 s; Pe9=7.8 Hz;
45. Computer screen=50 Hz; 18 Hz; 9 Hz
46 Pe9 before=0.25 Hz; Pe9=50 Hz after 10 minutes facing a computer screen 12″ away.
47 Urinary bladder stretch: pipette of blanked water at acupuncture points: Pe=5.5 Hz; He=5.5 Hz. UB meridian=5.5 Hz dowsed against coil EMF frequencies (typ)

1: Method to make a digital image with imprinted (image of reflected light modulated by coherent domains in trace water oscillating to EMF with those frequencies) endogenous acupuncture meridian frequencies (EAMF) in it comprising of:
A cardboard card (card)
a. Tune signal generator to an EAMF
b a layer of moisture on the card—from normal humidity—with coherent domains (CD) will be imprinted—oscillating—to an EMF frequency from a coil,
c photograph modulated light reflected off card which is modulated by CD.

2: Method to imprint—oscillate—coherent domains in the index finger and acupuncture meridians and stimulate acupuncture meridians comprising of:
Cardboard card
Index finger
Skin of the index finger of person touching the screen
Body of person touching the image on the screen
a. Display image of card with imprinted EAMF on smart phone
b touch image on screen for 30 s to 120 s with index finger
c. Modulated light will penetrate the skin of the index finger to reach water in the finger and body with CDs and imprint—oscillate—CDs to the EAMF frequencies, then the CDs will diffuse through the meridians and body of the person touching the image on the screen for 5-10 minutes.
